(19) United States
(12) Patent Application Publication
(10) Pub. No.: US 2024/0367506 A1
(43) Pub. Date: Nov. 7, 2024

(54) HOLDING FRAME FOR FASTENING HIGH-PRESSURE STORAGE TANKS TO VEHICLES, MORE PARTICULARLY A UTILITY VEHICLE, AND VEHICLE HAVING THE HOLDING FRAME

(71) Applicant: ARGO GMBH, Wesel (DE)

(72) Inventors: Jan ANDREAS, Wesel (DE); Lucky BAGHA, Wesel (DE)

(21) Appl. No.: 18/291,172

(22) PCT Filed: Jul. 18, 2022
(86) PCT No.: PCT/EP2022/070022

§ 371 Date: Jan. 22, 2024

(30) Foreign Application Priority Data
Jul. 23, 2021 (DE) 10 2021 207 941.5

(51) Int. Cl. B60K 15/07; B60K 15/03

(52) U.S. Cl. CPC B60K 15/07; B60K 2015/03118

(57) ABSTRACT

The present invention relates to a holding frame for attaching high-pressure storage tanks to a vehicle. Also disclosed are high-pressure fuel storage systems including the holding frame, as well as vehicles including the high-pressure fuel storage system.

### TECHNICAL FIELD

The present invention relates to a holding frame for attaching high-pressure storage tanks to vehicles, in particular commercial vehicles, and a vehicle, in particular a commercial vehicle, comprising the holding frame according to the invention for attaching high-pressure storage tanks.

### PRIOR ART

In recent years, more and more vehicle manufacturers have been presenting motor vehicles powered by gaseous fuels such as natural gas, LPG or hydrogen. These include not only passenger cars, but also buses, trucks and forklifts. The attachment of the fuel tanks, in particular high-pressure storage tanks, presents a particular challenge in this regard, especially since the necessary attachment must ensure that the tanks are held or secured safely and securely to the vehicle even in the event of an accident.

High-pressure storage tanks are traditionally attached to frames, and thus to the respective vehicle, by means of loops or metal retaining straps. However, such holding devices are not sufficiently torsion-resistant, and thus, in the event of an accident, in particular a head-on collision with another vehicle, in which acceleration forces in the range of several G act on the vehicle, in particular on the high-pressure storage tanks, the holding device is easily deformed and a secure holding of the high-pressure storage tanks therefore cannot be guaranteed. In the worst case, this can lead to undesirable damage to the storage tanks and thus to an uncontrolled release of the fuel, in particular the gaseous hydrogen.

There is therefore a great need for torsion-resistant attachment devices or holding systems for securely attaching and holding high-pressure storage tanks on vehicles, in particular commercial vehicles, which, owing to the high weight of the commercial vehicle (for example truck+trailer) plus its load, require a large amount of fuel, in particular hydrogen, which means that the necessary high-pressure storage system must be configured to be accordingly large.

### DESCRIPTION OF THE INVENTION

Against the background of the need described above, one object of the present invention is to provide a holding frame for attaching at least one high-pressure storage tank to a vehicle, in particular a commercial vehicle, which is on the one hand capable of attaching the high-pressure storage tanks securely to the vehicle such that even in the event of an accident, in which high forces and moments can act on the tanks, the tanks can be held securely on the vehicle and torsion of the holding frame can be reduced or completely prevented, and at the same time the holding device can be optimised in terms of its own weight.

The aforementioned object is solved by means of a holding frame according to claim 1, a high-pressure storage system according to claim 12 and a vehicle according to claim 16. Preferred further developments of the invention are specified in the dependent claims.

One of the basic ideas of the present invention is to provide a holding frame for attaching high-pressure storage tanks to a vehicle, in which the high-pressure storage tanks are held directly by a support device attached to the vehicle chassis (vehicle frame) via a base structure, without interposing retaining straps, as a result of which the forces and moments occurring in the event of an accident can be transferred directly from the tanks to the vehicle chassis via the support device. The provided holding frame is furthermore supposed to make it possible to arrange the attachment of the tanks directly above the vehicle chassis, in particular the longitudinal beams of the truck, so that only low forces and moments act on the chassis.

In this manner, the rigidity of the holding or attachment of the high-pressure storage tank(s) to the vehicle can be improved, thus ensuring the integrity of the attachment of the high-pressure storage tanks even in the event of a head-on collision in which acceleration forces in the range of several G act on the tanks.

According to one aspect of the present invention, a holding frame for attaching high-pressure storage tanks to a vehicle, in particular a commercial vehicle, comprises: a base structure, in particular base plate(s), which is configured to be attached to a counter-structure of the vehicle, in particular a vehicle frame or vehicle chassis, and a support device that is configured to receive at least one high-pressure storage tank, in particular a hydrogen tank, the support device comprising a first support member consisting of at least two shell elements or holding members spaced apart from one another at a predetermined distance in the transverse direction of the vehicle, the shell elements comprising a preferably arcuate first receiving portion that is configured to encircle the at least one preferably cylindrical high-pressure storage tank over a predetermined angular range.

In the context of the present invention, the term “encircle” describes that the preferably two shell elements, which consist of plates as will be described in more detail below, have a receiving portion (the first receiving portion) at the end face thereof, in which the at least one high-pressure storage tank is received such that it comes at least partially into contact with the end face over the predetermined angular range. The high-pressure storage tank can rest directly on the end face, or a buffer member, such as a hard rubber member, may be arranged therebetween to dampen impacts or vibrations between the shell element and the high-pressure storage tank.

As already mentioned above, this makes it possible to increase the rigidity of the holding or attachment of the high-pressure storage tanks to the vehicle, as a result of which the high-pressure storage tank or tanks can be securely attached to the vehicle, in particular in the event of an accident involving the vehicle.

In the context of the present invention, the terms “vehicle” or “means of transport” or other similar terms as used below include motor vehicles in general, such as passenger automobiles including sports utility vehicles (SUVs), buses, trucks, various commercial vehicles, water vehicles including various boats and ships, aircraft, trains and the like, hybrid vehicles, electric vehicles, plug-in hybrid electric vehicles, hydrogen vehicles and other alternative vehicles (e.g. fuels gained from resources other than petroleum). As stated herein, a hybrid vehicle is a vehicle with two or more energy sources, for example, petrol-powered and simultaneously electric-powered vehicles.

According to one embodiment of the present invention, it can be advantageous to configure the support device to receive a plurality of high-pressure storage tanks, preferably 3 to 8, more preferred 4 to 6 high-pressure storage tanks, the two shell elements each comprising a number of first receiving portions corresponding to the number of high-pressure storage tanks to be received.

According to a further embodiment of the present invention, it may be advantageous for the at least one high-pressure storage tank to be used for storing fuel, in particular compressed gaseous and/or vaporous hydrogen.

It is furthermore advantageous if the two shell elements are each formed from a plate, in particular a metal plate, the longitudinal and width directions of which extend in a plane that includes the longitudinal direction of the vehicle (also the direction of travel of the vehicle) as well as the vertical direction (height direction of the vehicle) that extends perpendicular to the ground, the first receiving portion being formed in the plate and the plate preferably being provided with cut-outs for weight reduction.

The plate with the first receiving portion(s) and the preferably provided cut-outs can preferably be manufactured, in particular milled, from the solid, or a base plate can be prefabricated by laser cutting or flame cutting, which is then reworked, in particular re-milled, to the exact dimensions, whereby in particular the contact surfaces are reworked and the necessary holes are provided.

According to a further embodiment of the present invention, the plates of the two shell elements can be arranged with their longitudinal extension perpendicularly on the base structure, in particular the base plate, and, starting from the base structure, the width of the plates preferably reduces in the vertical direction (away from the base structure).

It is furthermore advantageous if the at least one first receiving portion is configured to encircle or receive the at least one preferably cylindrical high-pressure storage tank over an angular range α of at least 90 degrees and at most 180 degrees, preferably over an angular range α of 120 degrees to 180 degrees.

According to a further embodiment, the holding frame can furthermore comprise two stiffening plates, each of which is attached transversely (perpendicular to the respective plate, i.e. transverse to the vehicle direction) to one of the two shell elements, in particular to the end face of the plate that is orientated opposite the direction of travel, the stiffening plates preferably being welded to the respective shell element.

It is furthermore preferred that the holding frame also comprises a stiffening structure that is configured to support the two shell elements against one another in the transverse direction of the vehicle, in particular to brace them against one another by means of two cross tubes.

It can also be advantageous if the holding frame comprises a second support member that is configured to press the at least one high-pressure storage tank into the at least one first receiving portion of the two shell elements, preferably under pretension by a spring.

If the at least one high-pressure storage tank or the plurality of high-pressure storage tanks is/are pressed into the first receiving portion of the two shell elements under pretension by a spring, it can be ensured that, regardless of the filling pressure of the high-pressure storage tank(s), it/they can be pressed into the first receiving portion with the necessary force and at the same time it is made possible for the tank(s) to breathe.

It is furthermore advantageous if the second support member comprises two clamping members that are preferably each formed from a plate, in particular a metal plate, the longitudinal and width directions of the two plates extending in a plane that includes or contains the longitudinal direction of the vehicle as well as the vertical direction that extends perpendicular to the ground, with at least one second arcuate receiving portion being formed in the plate, which is configured to encircle the at least one high-pressure storage tank over a predetermined angular range.

According to a further embodiment of the present invention, it is advantageous if the at least one second receiving portion is configured to encircle the at least one preferably cylindrical high-pressure storage tank over an angular range β of at least 90 degrees and at most 180 degrees, preferably over an angular range β of 120 degrees to 180 degrees.

It is advantageous if the holding frame furthermore comprises a test console holder that is laterally arranged on or attached to one of the two shell elements and extends away from the shell element in the transverse direction of the vehicle.

It can also be advantageous if the holding frame furthermore comprises a stiffening plate that is attached to the stiffening structure, in particular the two cross tubes, in order to stiffen it, the stiffening plate preferably being supported on one of the two shell elements via two cross struts.

According to a further aspect of the present invention, the two shell elements comprise a plurality of first receiving portions, the uppermost of the first receiving portions encircling or receiving the high-pressure storage tank only from below in a range from 60 degrees to 120 degrees, preferably from 70 degrees to 90 degrees, and/or the two clamping members comprise a plurality of second receiving portions, the uppermost of the second receiving portions encircling or receiving the high-pressure storage tank only from below in a range from 60 degrees to 120 degrees, preferably from 70 degrees to 90 degrees.

It is furthermore advantageous if the at least one first receiving portion and the at least one second receiving portion are arranged such that together they encircle or receive the at least one high-pressure storage tank to be received over an angular range γ of at least 240 degrees to at most 360 degrees.

According to a further embodiment of the present invention, it is preferred that the base structure comprises two base plates that are preferably arranged, in particular spaced apart, one behind the other in the longitudinal direction of the vehicle, and both base plates are preferably provided with receiving grooves that extend in the longitudinal direction of the vehicle and are configured to each receive the two shell elements and clamping members.

It is furthermore preferred that the two base plates are each provided with lateral attachment flanges that are configured to attach the base structure to the counter-structure of the vehicle, in particular the vehicle frame, the attachment flanges preferably being screwed to the respective base plate, front and rear base plate.

It can also be advantageous to provide each of the attachment flanges with stiffening ribs and to preferably provide the attachment flanges with through-holes for attachment to the counter-structure of the vehicle.

The present invention furthermore relates to a high-pressure storage system for storing fuel, in particular compressed gaseous and/or vaporous hydrogen, which is preferably configured to supply a fuel cell system, in particular of a vehicle, with fuel, said system comprising: the above-described holding frame according to one of the described embodiments, at least one high-pressure storage tank for storing fuel, in particular compressed gaseous and/or vaporous hydrogen, and at least one on-tank valve that is configured to control, with and/or without feedback, the filling and/or withdrawal of fuel into or from the at least one high-pressure storage tank.

It can be advantageous that the high-pressure storage system furthermore comprises a thermal pressure relief device that is preferably integrated into the at least one on-tank valve and is configured to open an outlet of the on-tank valve by the action of heat, in particular when a predetermined temperature is reached, in order to protect the pressurized high-pressure storage tank from excess pressure, whereby the discharged fuel can preferably be discharged upwards via a vent line.

In this manner, it can be ensured that if a state occurs in which the pressure inside the tank reaches a dangerous level due to an increased ambient temperature, for example fire in the event of an accident, at which the integrity of the tank can no longer be ensured, the stored fuel, in particular the hydrogen, can be emptied in a controlled manner, with the discharged fuel preferably being discharged upwards or away from the vehicle in the height direction of the vehicle in order to protect persons or equipment from the escaping hydrogen which could ignite.

It can furthermore be advantageous if the high-pressure storage system also comprises: a plurality of high-pressure storage tanks, which are each provided with an on-tank valve and are preferably connected to one another in a gas-conducting manner by means of a valve device (GHU) such that a fuel cell system to be supplied can be supplied with fuel centrally via connection ports.

According to a further aspect of the present invention, the high-pressure storage system may further comprise a pressure storage tank attachment device configured to attach the at least one high-pressure storage tank to the holding frame, in particular to the first and/or second support members, the pressure storage tank attachment device preferably comprising a plurality of (preferably metallic) pressure storage tank attachment straps.

It is furthermore advantageous if the high-pressure storage system also comprises a power supply, in particular plug connections, via which the high-pressure storage system can be supplied with power or electricity, in particular can be supplied with electricity by the vehicle.

It is furthermore preferred that the high-pressure storage tank system comprises a support structure for attaching a pipework that is configured to supply fuel to and/or lead it away from the at least one high-pressure storage tank.

The present invention furthermore relates to a vehicle, in particular a commercial vehicle, more preferred a truck, which is preferably powered by a fuel cell drive, comprising: a vehicle frame (vehicle chassis), a passenger cabin, in particular a driver's cab, for accommodating people, and the above-described high-pressure storage system according to one of the described embodiments, wherein the high-pressure storage system is attached to the vehicle frame by means of the base structure of the holding frame, in particular is arranged or attached on the vehicle frame behind the vehicle cabin in the longitudinal direction or direction of travel of the vehicle.

It is advantageous if the fuel cell drive of the vehicle can be supplied with fuel, in particular compressed gaseous and/or vaporous hydrogen, via the high-pressure storage system.

It is furthermore preferred that the attachment flanges of the base structure, in particular of the base plates, are configured to be attached to longitudinal beams of the chassis of the vehicle, in particular of the truck, the holding frame preferably being configured such that the first support member and/or the second support member (112) are arranged centrally above the longitudinal beams of the vehicle chassis.

In this manner, it can be ensured that the weight of the holding frame is arranged directly above the longitudinal beams of the vehicle and that the forces and moments of the holding frame which are introduced into the vehicle, in particular into the vehicle frame, from the holding frame when the vehicle is driving are directly introduced into the longitudinal beams of the vehicle chassis without a large lever arm, as a result of which the moments introduced into the longitudinal beams can be minimized.

### BRIEF DESCRIPTION OF THE FIGURES

Further features and advantages of a device, a use and/or a method are apparent from the following description of embodiments with reference to the accompanying figures. In these figures:

FIG. 1 schematically shows the structure of a known holding device for attaching high-pressure storage tanks to vehicles,

FIG. 2 schematically shows the structure of another known holding device for attaching high-pressure storage tanks to trucks,

FIG. 3 schematically shows the structure of a high-pressure storage system according to an embodiment of the present invention,

FIG. 4 schematically shows the structure of a holding frame according to an embodiment of the present invention (without high-pressure storage tanks),

FIG. 5 schematically shows the structure of a base structure comprising a shell element and a corresponding clamping member according to an embodiment of the present invention, and

FIG. 6 shows a basic structure according to an embodiment of the present invention.

### DESCRIPTION OF EMBODIMENTS

Identical reference numbers that are used in different figures designate identical, corresponding or functionally similar elements.

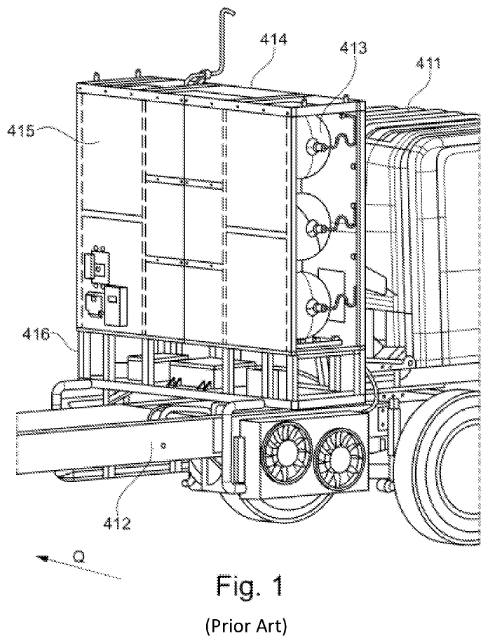

FIG. 1 schematically shows the structure of a known holding device for attaching hydrogen tanks 413 (high-pressure storage tanks) to a commercial vehicle, in particular a truck. As is apparent from FIG. 1, the hydrogen tanks are usually, at least in Europe, arranged behind the driver's cab 411. This is due to the fact that, in Europe, the length of commercial vehicles is limited and therefore the installation space for installing hydrogen tanks in the vehicle is limited. As is furthermore apparent from FIG. 1, the hydrogen containers 414 are mounted in a steel frame 416 consisting of individual steel profiles and the steel frame is clad with individual steel sheets 415. However, such holding devices do not have a sufficient inherent rigidity, and thus, in particular in the event of an accident, the holding device tends to be easily deformed due to the high moments of inertia and tends to exert high forces and moments on or introduce high forces and moments to the vehicle frame (vehicle chassis) 412. As is also apparent from FIG. 1, the hydrogen tanks 413 are arranged with their longitudinal direction or longitudinal extension in a transverse direction (Q) of the truck.

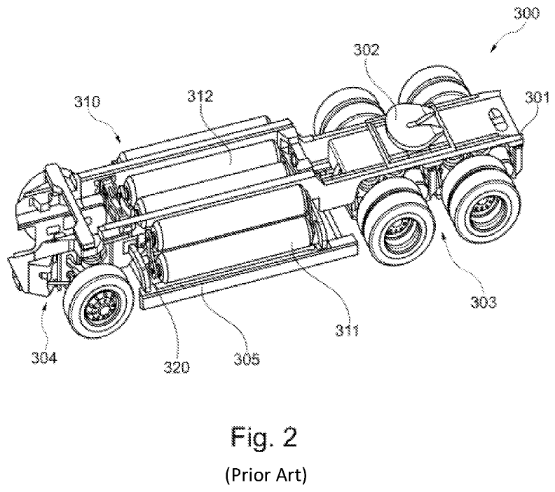

FIG. 2 schematically shows the structure of a further known holding device for attaching high-pressure storage tanks to trucks. This is a holding device for trucks designed for use in North America or Australia, where the length of the truck or towing vehicle is not as strictly regulated. In these countries, it seems expedient to accommodate the hydrogen tanks 311, 312 with their longitudinal extension in the direction of travel of the vehicle or in the longitudinal direction of the vehicle. In the truck chassis 300 shown in FIG. 2, the underbody of the truck is shown, which consists of the longitudinal frame 301, the front axle 304, the rear axle 303 consisting of two axles, and the semitrailer coupling 302, which is used to attach a semitrailer (not shown).

In the embodiment shown in FIG. 2, the lateral hydrogen tanks 311 of the hydrogen storage system 310 are integrated into the lateral underride guard 305 and are attached to the longitudinal frame 301 of the truck by means of two holding devices 320. The shown hydrogen storage system 310 furthermore comprises central hydrogen tanks 312, which are arranged between the two longitudinal beams of the longitudinal frame 301 of the truck.

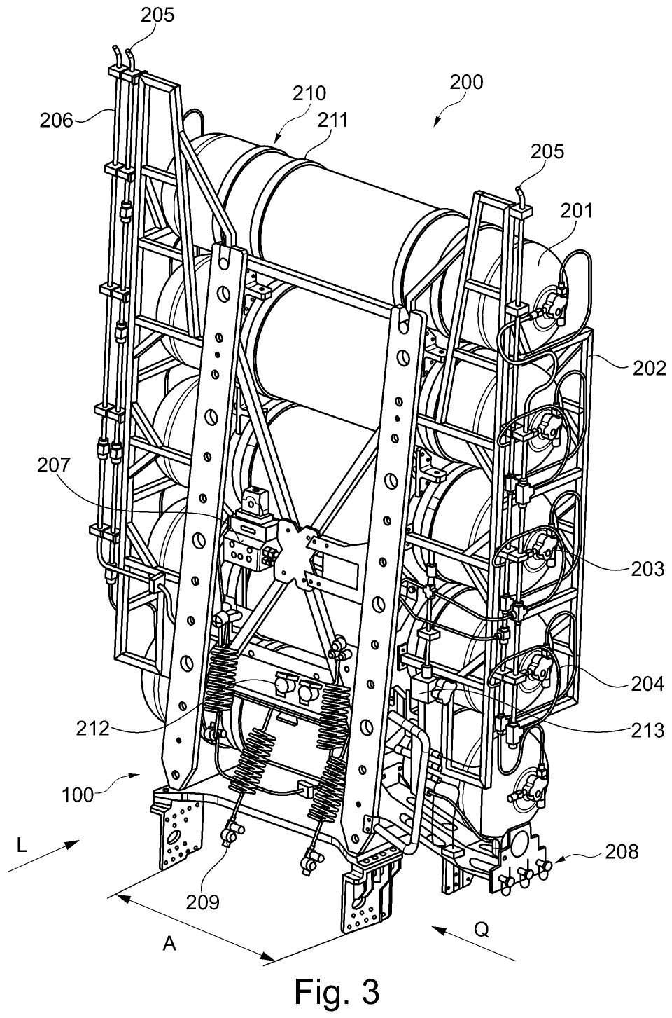

FIG. 3 schematically shows the structure of a high-pressure storage system 200 according to an embodiment of the present invention. As is apparent from FIG. 3, the high-pressure storage system 300 consists of a holding frame 100 that serves to attach the high-pressure storage system 300, in particular the hydrogen tanks thereof, to the chassis of a truck. The shown high-pressure storage system 300 comprises five cylindrical hydrogen tanks 201 that are stacked vertically one on top of the other (in the height direction of the truck), in particular are stacked congruently one on top of the other. As FIG. 3 further shows, all the hydrogen tanks 201 are provided with their own on-tank valve 203 (OTV) that is configured to control fuel filling with hydrogen and the removal of the hydrogen. A thermal pressure relief device (TPRD) can furthermore be integrated into the on-tank valve 203, which is configured such that when a predetermined maximum temperature is reached (for example in the event of a fire after an accident), the hydrogen tanks 201 can be emptied in a controlled manner via one or more vent lines 205, which preferably lead upwards (in particular above the cab of the truck) as shown. The high-pressure storage system (200) is further provided with a central valve device (207), in particular a gas handling device, which serves to control, with or without feedback, the entire hydrogen flow within the high-pressure storage system 200 and between the high-pressure storage system 200 and the truck. The system 200 furthermore comprises connection ports 209 that serve to supply the fuel cell system of the truck centrally with fuel (hydrogen).

As is furthermore apparent from FIG. 3, the system 200 comprises pressure storage tank attachment straps or pressure storage tank attachment buckles that serve to attach the individual high-pressure storage tanks (hydrogen tanks) 201 to the holding frame 100 and thereby enable the hydrogen tanks 201 to breathe. In the present context, breathing is understood to mean that the hydrogen tanks 201 can expand or contract in diameter depending on the storage pressure of the filled hydrogen. The high-pressure storage system 200 is furthermore provided with a power supply 212, in particular plug connections, via which the system 200 can be supplied with electricity from the truck. The shown high-pressure storage system 200 furthermore comprises a support structure 202 for attaching a pipework 204 that serves to conduct the hydrogen to the hydrogen tanks 201 during filling and to conduct hydrogen from the tanks to the truck when supplying the truck with hydrogen. The support structure 202 can also be used to attach the two vent lines 205. As is also apparent from FIG. 3, a further vent line 206 is attached to the support structure 202, which serves to vent the gas handling device 207. The shown system 200 is furthermore provided with a test console 208 which on the one hand serves to carry out, for example, a leak test on the system 200 and on the other hand can be used for filling and emptying the high-pressure storage system 200.

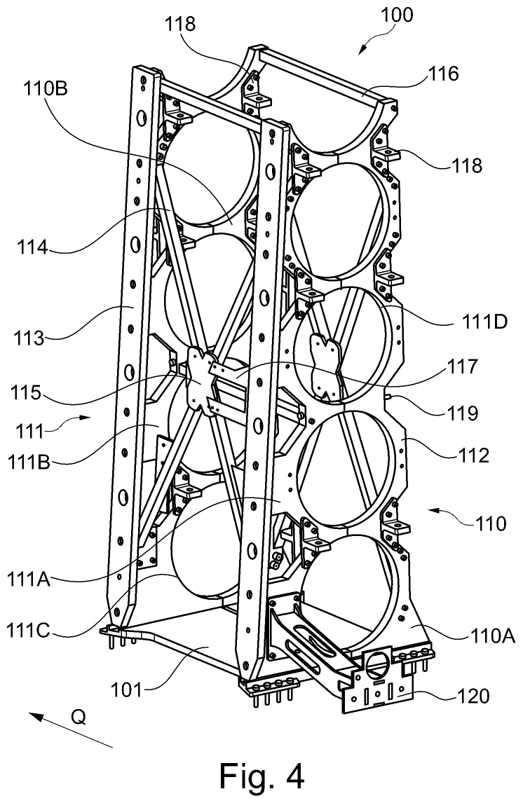

FIG. 4 schematically shows the structure of a holding frame 100 according to an embodiment of the present invention, in which the high-pressure storage tanks 201 are not shown for ease of viewing. As is apparent from the figure, the shown holding frame 100 comprises a base structure 101, which is formed from two base plates 131 and 132 and is configured to be attached to a vehicle frame of a vehicle (not shown), and a support device 110, which is configured to receive five high-pressure storage tanks 201. For this purpose, the support device 110 comprises a first support member 111 that consists of at least two shell elements 111A, 111B (plates) spaced apart from one another by a predetermined distance A in the transverse direction Q of the vehicle. The shell elements 111A, 111B each comprise five approximately circular first receiving portions 111C, which are configured to encircle or receive the cylindrical high-pressure storage tanks 201 shown in FIG. 3 over an angular range α of approximately 180 degrees. The uppermost of the first receiving portions 111 is configured such that it only encircles the hydrogen tank 201 over an angle of less than 90 degrees so that the hydrogen tank 201 is only supported from below and slightly from the side. As is furthermore apparent from FIG. 4, the two shell elements 111A and 111B are each stiffened by a stiffening plate 113 provided on the end face of the respective shell element, which in particular increases the rigidity of the two shell elements 111A and 111B in the transverse direction Q (width direction) of the holding frame, which corresponds to the transverse direction Q of the vehicle (in the state installed in the vehicle).

FIG. 4 also shows that the holding frame 100 can additionally be provided with a stiffening structure 114 that serves to brace the two shell elements 111, 111B against one another in the transverse direction Q of the holding frame (transverse direction of the vehicle) by means of two cross tubes (raw profiles).

According to the shown embodiment, the holding frame 100 furthermore comprises a second support member 112 that serves to press the four lower hydrogen tanks 201 into the respective first receiving portion 111C of the two shell elements 111A, 111B, and for this purpose, the second support member 112 can be pretensioned against the hydrogen tanks 201 by means of a spring. The second support member consists of two clamping members 112A, 112B, which are each also formed from a plate, in particular a metal plate, the longitudinal and width directions L, B of the two plates extending in a plane E that includes the longitudinal direction of the vehicle as well as the vertical direction that extends perpendicular to the ground (base plate), wherein five arcuate, in particular circular, receiving portions 111D are also formed in the two plates, which serve to encircle the five high-pressure storage tanks 201 over an angular range of approximately 180 degrees (the uppermost tank over only approximately 90 degrees). The holding frame is furthermore provided with a test console holder 120, on which test connections or a filling connection for filling the high-pressure storage system 200 with hydrogen can be provided.

The holding frame 100 furthermore comprises a stiffening plate 115 that is attached to the stiffening structure 114, in particular the two cross tubes thereof, and serves to stiffen them against one another, wherein the stiffening plate can be supported on one of the two shell elements 111A, 111B by means of two cross struts 117. As is also apparent from FIG. 4, the first receiving portions 111C and second receiving portion 111D, which are each arranged complementary to one another, are each arranged in such a way that they can together encircle or receive the high-pressure storage tank 201 to be received over an angular range γ of 240 degrees to 360 degrees. In the shown embodiment, they encircle the tanks by approximately 360 degrees.

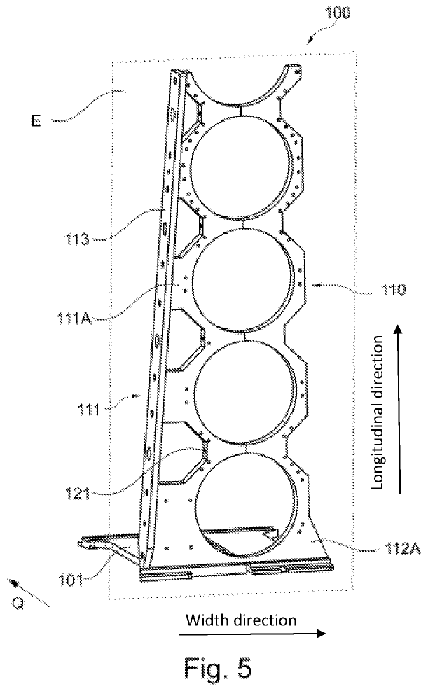

FIG. 5 schematically shows the structure of a base structure 101 with a shell element 111A and a corresponding clamping member 112A according to an embodiment of the present invention. As already described above, the two elements 111A, 111B are formed of a metal plate, the longitudinal and width directions L, B of which extend in a plane E that includes the longitudinal direction of the vehicle (also the direction of travel of the vehicle) as well as the vertical direction (height direction of the vehicle) that extends perpendicular to the ground or base plate 131, 132, wherein cut-outs are provided in the plate of the shell element 111A for weight reduction.

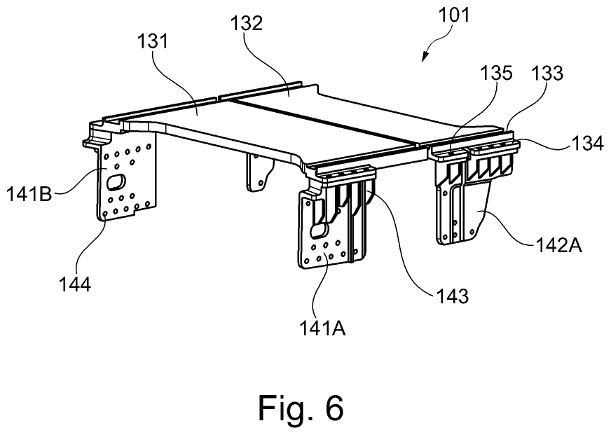

FIG. 6 furthermore shows a base structure 101 according to an embodiment of the present invention. As is apparent from FIG. 6, the base structure 101 comprises two base plates 131, 132, which are preferably arranged one behind the other, in particular at a distance, in the longitudinal direction of the vehicle, and both base plates 131, 132 are provided with receiving grooves 133 that extend in the longitudinal direction of the vehicle and are configured to each receive the two shell elements 111A, 111B and clamping members 112A, 112B, as a result of which transverse forces acting on the shell elements 111A, 111B and the clamping members 112A, 112B can be introduced more effectively into the base plates 131, 132.

FIG. 6 also shows that the two base plates 131, 132 are each provided laterally (in the transverse direction) with attachment flanges 141A, 141B; 142A, 142B, which serve to be able to attach the base structure 101 to the counter-structure of the vehicle, in particular the vehicle frame, in particular to be able to attach it thereto by means of screw connections. The attachment flanges 141A, 141B; 142A, 142B can be screwed or welded to the respective base plate 131, 132. The attachment flanges 141, 141B; 142A, 142B are each provided with stiffening ribs 143 for stiffening, the attachment flanges 141, 141B; 142A, 142B having through-holes 144 for attachment to the counter-structure of the vehicle.

### LIST OF REFERENCE NUMBERS

100 Holding frame
10 Base structure
110 Support device
111 First support member
111A, 111B Shell elements
111C First receiving portion
112 Second support member
112A, 112B Clamping members
113 Stiffening plates
114 Stiffening structure
120 Test console holder
131 (Front) base plate
132 (Rear) base plate
133 Receiving grooves
141, 142 Attachment flanges
143 Stiffening ribs
144 Through-holes
200 High-pressure storage system
201 High-pressure storage tanks
202 Support structure for pipework
203 Valve device (OTV)
204 Pipework (supply and discharge line)
205 Vent line (OTVs)
206 Vent line (GHU)
207 Valve device (GHU)
208 Test console
209 Connection ports to the vehicle
210 Pressure storage tank attachment device
211 Pressure storage tank attachment straps
212 Power supply from the vehicle

1. A holding frame for attaching high-pressure storage tanks to a vehicle, the holding frame comprising:
a base structure, which is configured to be attached to a counter-structure of the vehicle; and
a support device that is configured to receive at least one high-pressure storage tank,
wherein:
the support device comprises a first support member consisting of at least two shell elements spaced apart from one another at a predetermined distance (A) in the transverse direction (Q) of the vehicle; and
the shell elements comprise a first receiving portion that is configured to encircle at least one high-pressure storage tank over a predetermined angular range (α).

2. The holding frame according to claim 1, wherein the support device is configured to receive a plurality of high-pressure storage tanks, and wherein the two shell elements each comprise a number of first receiving portions corresponding to the number of high-pressure storage tanks to be received.

3. The holding frame according to claim 1, wherein the two shell elements are each formed from a plate, the longitudinal and width directions (L, B) of which extend in a plane (E) that includes the longitudinal direction of the vehicle as well as the vertical direction that extends perpendicular to the ground or parallel to the direction of gravity, and wherein the first receiving portion is formed in the plate.

4. The holding frame according to claim 1, wherein the at least one first receiving portion is configured to encircle the at least one high-pressure storage tank over an angular range (α) of at least 90 degrees and at most 180 degrees.

5. The holding frame according to claim 1, further comprising two stiffening plates, each of which is attached transversely (perpendicular to the plate) to one of the two shell elements.

6. The holding frame according to claim 1, further comprising a stiffening structure that is configured to support the two shell elements against one another in the transverse direction (Q) of the vehicle.

7. The holding frame according to claim 1, further comprising a second support member that is configured to press the at least one high-pressure storage tank into the at least one first receiving portion of the two shell elements.

8. The holding frame according to claim 7, wherein the second support member comprises two clamping members, wherein the longitudinal and width directions (L, B) of two plates extend in a plane (E) that includes the longitudinal direction of the vehicle as well as the vertical direction that extends perpendicular to the ground, and wherein at least one second arcuate receiving portion is formed in the plate, which is configured to encircle the at least one high-pressure storage tank over a predetermined angular range (β).

9. The holding frame according to claim 1, further comprising a test console holder that is laterally arranged on one of the two shell elements and extends away from the shell element in the transverse direction (Q) of the vehicle.

10. The holding frame according to claim 1, wherein the base structure comprises two base plates that are arranged one behind the other in the longitudinal direction of the vehicle, and both base plates are provided with receiving grooves that extend in the longitudinal direction of the vehicle and are configured to each receive the two shell elements and clamping members.

11. The holding frame according to claim 10, wherein the two base plates are each provided with lateral attachment flanges that are configured to attach the base structure to the counter-structure of the vehicle.

12. A high-pressure storage system for storing fuel, the high-pressure storage system comprising:
the holding frame of claim 1;
at least one high-pressure storage tank for storing fuel; and
at least one on-tank valve that is configured to control, with or without feedback, the filling and/or withdrawal of fuel.

13. The high-pressure storage system according to claim 12, further comprising: a thermal pressure relief device that is configured to open an outlet of the on-tank valve by the action of heat, in order to protect the pressurized high-pressure storage tank from excess pressure.

14. The high-pressure storage system according to claim 12, further comprising: a plurality of high-pressure storage tanks, which are each provided with an on-tank valve.

15. The high-pressure storage system according to claim 12, further comprising a pressure storage tank attachment device configured to attach the at least one high-pressure storage tank to the holding frame.

16. A vehicle, comprising:
a vehicle frame;
a passenger cabin; and
the high-pressure storage system according to claim 12,
wherein the high-pressure storage system is attached to the vehicle frame by the base structure of the holding frame.

17. The vehicle according to claim 16, wherein a fuel cell drive of the vehicle can be supplied with fuel via the high-pressure storage system.

18. The vehicle according to claim 16, wherein attachment flanges of the base structure are configured to be attached to longitudinal beams of the chassis of the vehicle.
